(19) United States
(12) Patent Application Publication
(10) Pub. No.: US 2016/0044684 A1
(43) Pub. Date: Feb. 11, 2016

(54) SYSTEMS AND METHODS FOR REDUCING INTERFERENCE IN SHORT-RANGE COMMUNICATION CHANNELS

(71) Applicants: SHAHRNAZ AZIZI, Cupertino, CA (US); ELDAD PERAHIA, Portland, OR (US); THOMAS KENNEY, Portland, OR (US)

(72) Inventors: SHAHRNAZ AZIZI, Cupertino, CA (US); ELDAD PERAHIA, Portland, OR (US); THOMAS KENNEY, Portland, OR (US)

(21) Appl. No.: 14/455,283

(22) Filed: Aug. 8, 2014

(51) Int. Cl. H04W 72/08; H04W 72/04; H04L 5/00; H04W 4/00

(52) U.S. Cl. CPC H04W 72/082; H04W 4/008; H04W 72/048; H04L 5/0023

(57) ABSTRACT

The present disclosure relates to computer-implemented systems and methods for transmitting and receiving audio and video data. A method may include receiving, by a device including one or more processors and a radio transceiver, an indication that the device is a short-range communication second device. The method may also include determining that the short-range communication second device is located outside of a vehicle. Furthermore, the method may include identifying, upon determination that the short-range communication second device is located outside of the vehicle, a short-range communication client device. Additionally, the method may include transmitting, to the short-range communication client device, a request for a peer-to-peer connection in a short-range communication channel.

### TECHNICAL FIELD

The present disclosure generally relates to wireless communication, and in particular, to managing short-range communication.

### BACKGROUND

Recently, the Federal Communications Commission has proposed allowing consumer devices to access short-range communication channels, which may be typically used by vehicle communication systems. For example, vehicle systems may use dedicated short-range communication (DSRC) systems for a wide variety of functions, such as collision avoidance, emergency response, and/or other safety related features. As such, consumer devices that desire to establish communications in short-range communication channels may be configured to avoid interfering with vehicle communication systems operating in such channels.

### BRIEF DESCRIPTION OF THE DRAWINGS

Reference will now be made to the accompanying figures and diagrams, which are not necessarily drawn to scale, and wherein:

FIG. 1 shows a block diagram of a system for reducing interference in short-range communication channels, according to one or more example embodiments.

FIG. 2 shows a schematic diagram of one or more communication channels according to one or more example embodiments.

FIG. 3 show a flow diagram for reducing interference in short-range communication channels, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “mobile device” and/or “device” refers, in general, to a wireless communication device, and more particularly to one or more of the following: a portable electronic device, a telephone (e.g., cellular phone, smart phone), a computer (e.g., laptop computer, tablet computer), a portable media player, a personal digital assistant (PDA), or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of the server may include a web server hosting one or more web pages. Some examples of web pages may include social networking web pages. Another example of a server may be a cloud server that hosts web services for one or more computer devices.

As used herein, unless otherwise specified, the term “receiver” may refer to any device or component capable of receiving data, signals, information, etc. For example, a receiver may include an antenna or any other second device.

As used herein, unless otherwise specified, the term “transmitter” may refer to any device or component capable of transmitting data, signals, information, etc. For example, a transmitter may also include an antenna or any other transmission device.

As used herein, unless otherwise specified, the term “transceiver” may refer to any device or component capable of performing the functions of a receiver and/or a transmitter. For example, transceivers may include, but are not limited, antennas, amplifiers, filters, modulation and/or demodulation components, analog-to-digital converters, digital-to-analog converters, and/or the like.

According to certain embodiments, the functionality provided by the receiver and the transmitter may be included in a single transceiver device.

The present disclosure relates to computer-implemented systems and methods for transmitting and receiving audio and video data. According to one or more embodiments of the disclosure, a device is provided. The device may include a radio transceiver and at least one memory for storing data and computer-executable instructions. Additionally, the device may also include at least one processor to access the at least one memory and to execute the computer-executable instructions. Furthermore, the at least one processor may be configured to execute the instructions to receive an indication that the device is a short-range communication second device. Additionally, the at least one processor may be configured to execute the instructions to determine that the short-range communication second device is located outside of a vehicle. The at least one processor may also be configured to execute the instructions to identify, upon determination that the short-range communication second device is located outside of the vehicle, a short-range communication client device. The at least one processor may also be configured to execute the instructions to transmit, by the radio transceiver to the short-range communication client device, a request for a peer-to-peer connection in a short-range communication channel.

According to one or more embodiments of the disclosure, a method is provided. The method may include receiving, by a device including one or more processors and a radio transceiver, an indication that the device is a short-range communication second device. The method may also include determining that the short-range communication second device is located outside of a vehicle. Additionally, the method may include identifying, upon determination that the short-range communication second device is located outside of the vehicle, a short-range communication client device. The method may also include transmitting, to the short-range communication client device, a request for a peer-to-peer connection in a short-range communication channel.

According to one or more embodiments of the disclosure, a non-transitory computer-readable medium is provided. The non-transitory computer-readable medium may have embodied thereon instructions executable by one or more processors. The instructions may cause the one or more processors to receive an indication that the device is a short-range communication second device. Additionally, the computer-readable medium may include instructions to determine that the short-range communication second device is located outside of a vehicle. Moreover, the computer-readable medium may include instructions to identify, upon determination that the short-range communication second device is located outside of the vehicle, a short-range communication client device. The computer-readable medium may also include instructions to transmit, to the short-range communication client device, a request for a peer-to-peer connection in a short-range communication channel.

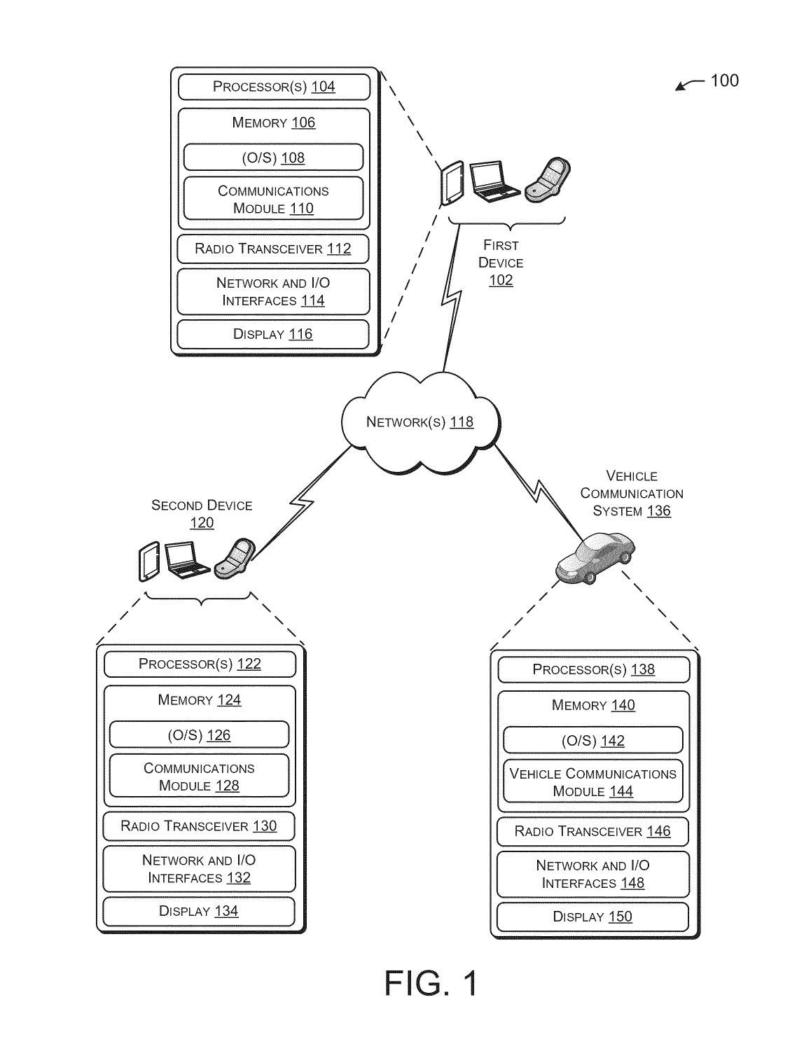

The above principles, as well as perhaps others, are now illustrated with reference to FIG. 1, which depicts a system 100 for managing short-range communication. The system 100 may include a first device 102 having one or more computer processors 104 and a memory 106, which may store an operating system 108. The first device 102 may further include a communications module 110, a radio transceiver 112, network and input/output (I/O) interfaces 114, and a display 116 in communication with each other.

The system 100 may also include a network 118 to facilitate communication between the first device 102, a second device 120, and a vehicle communication system 136. The second device 120 may include one or more computer processors 122, and a memory 124, which may include an operating system 126. The second device 120 may further include, a communications module 128, a radio transceiver 130, network and input/output (I/O) interfaces 132, and a display 134 in communication with each other.

The vehicle communication system 136 may include one or more computer processors 138, and a memory 140, which may include an operating system 142. The vehicle communication system 136 may further include, a communications module 144, a radio transceiver 146, network and input/output (I/O) interfaces 148, and a display 150 in communication with each other. It will be appreciated that all radio transceivers 112/130/146 described with respect to the first device 102, second device 120, and the vehicle communication system 136 may be configured to receive and/or transmit any type of radio signals (e.g., Dedicated short-range communication (DSRC) signals, WiFi radio signals, Bluetooth radio signals, Bluetooth Low-Energy radio signals, etc.).

The computer processors 104/122/138 may comprise one or more cores and may be configured to access and execute (at least in part) computer-readable instructions stored in the memory 106/124/140. The one or more computer processors 104/122/138 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The client devices 102 may also include a chipset (not shown) for controlling communications between the one or more processors 104/122/138 and one or more of the other components of the first device 102. In certain embodiments, the first device 102, second device 120, and/or vehicle communication system 136 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106/124/140 may comprise one or more computer-readable storage media (CRSM). In some embodiments, the memory 106/124/140 may include non-transitory media such as random access memory (RAM), flash RAM, magnetic media, optical media, solid-state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106/124/140 may store an operating system that includes a plurality of computer-executable instructions that may be implemented by the computer processor 104/122/138 to perform a variety of tasks to operate the interface(s) and any other hardware installed on the first device 102. The memory 106/124/140 may also store content that may be displayed by the first device 102 or transferred to other devices (e.g., headphones) to be displayed or played by the other devices. The memory 106/124/140 may also store content received from the other devices. The content from the other devices may be displayed, played, or used by the first device 102 to perform any necessary tasks or operations that may be implemented by the computer processor 104/122/138 or other components in the first device 102, second device 120, and/or vehicle communication system 136.

According to certain embodiments, the memory 106/122 may also store a communications module 110/132. The communication module 110/132 may be configured to facilitate communication with other devices (e.g., between client devices 102A/120B and master devices 120). To this end, the communication module 110/132 may be configured to operate using various network protocols and layers, such as a Transmission Control Protocol (TCP)/Internet Protocol (IP), Ethernet, media access control layers, and/or the like. The communications module 110/132 may also be interact with the network and I/O interfaces 114/134 to facilitate communication using various networking standards and interfaces, as described below.

The network and I/O interfaces 114/132/148 may comprise one or more communication interfaces or network interface devices to provide for the transfer of data between the first device 102 and another device (e.g., network server) via a network (not shown). The communication interfaces may include, but are not limited to: body area networks (BANs), personal area networks (PANs), wired local area networks (LANs), wireless local area networks (WLANs), wireless wide area networks (WWANs), and so forth. The first device 102 may be coupled to the network via a wired connection. However, the wireless system interfaces may include the hardware and software to broadcast and receive messages either using the Wi-Fi Direct Standard and/or the IEEE 802.11 wireless standard, the Bluetooth standard, the Bluetooth Low-Energy standard, the Wi-Gig standard, and/or any other wireless standard and/or a combination thereof. The wireless system may include a transmitter and a receiver or a transceiver capable of operating in a broad range of operating frequencies governed by the IEEE 802.11 wireless standards. The communication interfaces may utilize acoustic, radio frequency, optical, or other signals to exchange data between the first device 102, second device 120, and/or vehicle communication system 136 and another device such as an access point, a host computer, a server, a router, a reader device, and the like. The network 118 may include, but is not limited to: the Internet, a private network, a virtual private network, a wireless wide area network, a local area network, a metropolitan area network, a telephone network, and so forth.

The display 116/134/150 may include, but is not limited to, a liquid crystal display, a light-emitting diode display, or an E-Ink™ display as made by E Ink Corp. of Cambridge, Mass. The display may be used to show content to a user in the form of text, images, or video. In certain instances, the display may also operate as a touch screen display that may enable the user to initiate commands or operations by touching the screen using certain finger or hand gestures.

According to one or more embodiments, both the first device 102 and the second device 120 may be short-range communication (SRC) devices. For instance, both the first device 102 and the second device 102 may be dedicated short-range communication (DSRC) devices capable of communication in one or more DSRC channels. Furthermore, the first device 102 and the second device 120 may be configured to communication in DSRC channel frequencies of approximately 5.85 GHz to 5.925 GHz. It will be appreciated other channel frequencies are also contemplated. As previously discussed DSRC channels may typically be used by vehicle communication systems, such as the vehicle communication system 136 depicted in FIG. 1. Such uses may include emergency warning systems, collision avoidance systems, roadside assistance systems, and/or other safety related or communication related systems. In some embodiments, the vehicle communication system 136 may be configured to assume operating conditions free of communication interference from other devices (e.g., the first device 102 and the second device 120). Thus, the systems and methods described herein may facilitate communication between the first device 102 and the second device 120 in a SRC communication channel (e.g., a DSRC channel) while causing relatively low interference with the vehicle communications system 136. To this end, communication between the first device 102 and the second device 120 may be established in a SRC channel associated with certain channel bandwidth(s) using wireless signals associated with certain subcarrier spacing(s).

For example, according to certain embodiments, the first device 102 may detect, such as via the communications module 110, that a SRC signal is being transmitted in a first SRC channel. For example, the vehicle communication system 136 may be communicating in the first SRC channel and may be transmitting or receiving the SRC signal. The first SRC channel may be associated with a first channel bandwidth (e.g., approximately 10 MHz). In addition, the SRC signal may include multiple subcarriers, one or more of which may be associated with a first subcarrier spacing. The communications module 110 may detect the SRC signal using various methods. For example, the SRC signal may include one or more identifiers indicating that the signal is an SRC signal.

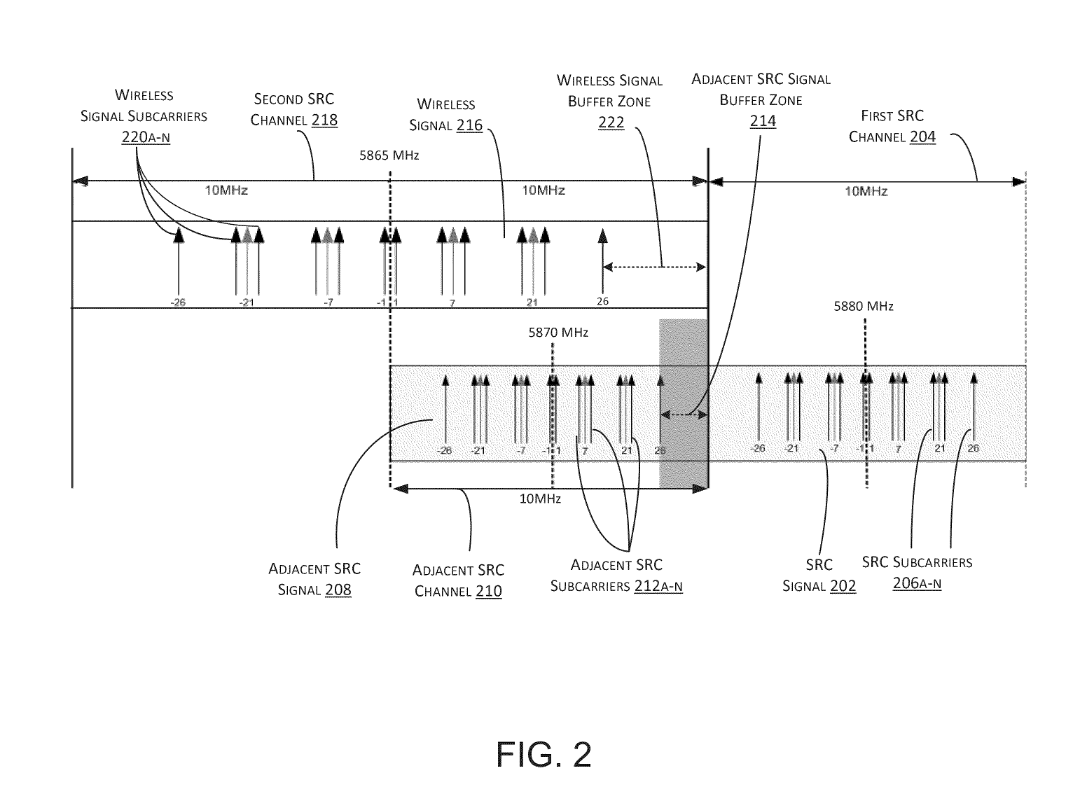

Additionally, the communications module 110 may also determine that communication is to be established with the second device 120 (e.g., via the communications module 128 included in the second device 120) in a second SRC channel (e.g., via Wi-Fi direct and/or any other communications standard). Furthermore, the first device 102 may determine that the second SRC channel is adjacent to the first SRC channel in which the vehicle communication system 136 is communicating. To this end, the first device 102 may be configured to transmit and/or receive, using the second SRC channel, a wireless signal to and/or from the second device 120. In certain embodiments, the second SRC channel may be associated with a second channel bandwidth, and the wireless signal may include multiple subcarriers, one or more of which may be associated with a second subcarrier spacing. In addition, the second channel bandwidth may be greater than the first channel bandwidth (e.g., approximately 20 MHz), and the second subcarrier spacing may be greater than the first subcarrier spacing. As a result, interference with communication of the vehicle communication system 136 in the first SRC channel may be reduced, as will be described in more detail with reference to FIG. 2.

Referring now to FIG. 2, a diagram 200 is depicted for reducing interference in SRC channels in accordance with one or more example embodiments. As shown in the diagram 200, an SRC signal 202 may be transmitted in a first SRC 204 channel. For instance, the vehicle communication system 136 may be configured to transmit and/or receive the SRC signal 202 in the first SRC channel 204. In certain implementations, the first SRC channel 204 may be associated with a first channel bandwidth (e.g., approximately 10 MHz). Additionally, the first SRC channel may operate in a channel frequency range of approximately 5875 MHz to 5885 MHz although it will be appreciated that various other SRC channel frequency ranges are also contemplated. Furthermore, the SRC signal 202 may include one or more SRC subcarriers 206A-N. As used herein, the SRC subcarriers 206A-N may refer to data subcarriers that transmit data. For example, the SRC signal 202 may include 2n number of subcarriers 206A-N that are capable of transmitting data. In certain implementations, the SRC signal 202 may include other subcarriers that do not transmit data (not illustrated).

According to certain embodiments, the SRC subcarriers 206A-N may be associated with a certain bandwidth portion of the first SRC channel 204. For example, each of the SRC subcarriers 206A-N may occupy and/or transmit on a certain portion of the first channel bandwidth. In certain instances, each of the SRC subcarriers 206A-N may occupy approximately the same amount of the first channel bandwidth (e.g., less than 1 MHz), and this amount may be referred to as “the subcarrier spacing.”

FIG. 2 may also illustrate an adjacent SRC signal 208 and a wireless signal 216. Both signals may be transmitted in respective channels that are adjacent to the first SRC channel. The adjacent SRC signal 208 may be associated with certain channel and signal characteristics typical under normal operating conditions. The wireless signal 216 may include certain channel and signal characteristics that may reduce interference on the SRC signal 202 when compared with the characteristics of the adjacent SRC signal 208. Thus, going forward, the description may describe and compare the characteristics of the wireless signal 216 with the adjacent SRC signal 208.

For example, under certain circumstances, an adjacent SRC signal 208 may be transmitted in an adjacent SRC channel 210. The adjacent SRC channel 210 may be adjacent to the first SRC channel 204. Similar to the SRC signal 202, the adjacent SRC signal 208 may be communicated by other vehicle communication systems and/or the like. As such, the adjacent SRC signal 208 may include similar signal characteristics as the SRC signal 202, and the adjacent SRC channel 210 may include similar channel characteristics as the SRC first SRC channel 204. For example, the adjacent SRC channel 210 may be associated with approximately the same channel bandwidth as the first SRC channel (e.g., approximately 10 MHz). Furthermore, the adjacent SRC signal 208 may include one or more adjacent SRC subcarriers 212A-N. As used herein, the adjacent SRC subcarriers 212A-N may be subcarriers capable of transmitting data. In addition, the number of adjacent SRC subcarriers 212A-N may be approximately equal to the number of SRC subcarriers 206A-N included in the SRC signal 202 (e.g., 2n number of subcarriers 212A-N). As a result of these similarities, the subcarrier spacing between the adjacent SRC subcarriers 212A-N may be approximately the same as the subcarrier spacing between the SRC subcarriers 206A-N.

Additionally, the adjacent SRC channel 210 may include an adjacent SRC signal buffer zone 214. The adjacent SRC signal buffer zone 214 may be a portion of the adjacent SRC channel 210, directly bordering the first SRC channel 204, for which no data is to be transmitted. As such, the adjacent SRC signal buffer zone 214 may facilitate the reduction of interference by the adjacent SRC signal 208 on the SRC signal 202. Moreover, the adjacent SRC signal buffer zone 214 may be comprised of one or more adjacent SRC guard subcarriers 215A-N included in the adjacent SRC signal 208. The adjacent SRC guard subcarriers 215A-N may be subcarriers in the adjacent SRC signal 208 that do not transmit data. To this end, the size of the adjacent SRC signal buffer zone 214 may be affected by the size and/or amount of subcarrier spacing associated with the adjacent SRC signal 208, as well as the number adjacent SRC guard subcarriers 215A-N. For instance, assuming a constant number of guard subcarriers 215A-N, a larger subcarrier spacing size may result in a larger SRC signal buffer zone 214. Similarly, assuming a constant subcarrier spacing size, a larger number of guard subcarriers 215A-N may also result in a larger SRC signal buffer zone 214.

According to one or more embodiments, a wireless signal 216 may be transmitted in a second SRC channel 218 between one or more communication devices, such as between the first device 102 and the second device 120. The second SRC channel may also be adjacent to first SRC channel 204. In certain implementations, the second SRC channel 218 may be associated with different signal characteristics than the first SRC channel 204 and the adjacent SRC channel 210. For example, the second SRC channel 218 may be associated with a relatively greater second channel bandwidth than the first SRC channel 204 and/or the adjacent SRC channel 210 (e.g., the second SRC channel 218 may include approximately 20 MHz of bandwidth compared to approximately 10 MHz).

Additionally, the wireless signal 216 may be associated with different signal characteristics than the SRC signal 202 and/or the adjacent SRC signal 208. For instance, the wireless signal 216 may include one or more wireless signal subcarriers 220A-N. In some implementations, the number of wireless signal subcarriers 220A-N may be approximately the same as the number SRC subcarriers 206A-N. Furthermore, the total number of subcarriers included in the wireless signal 216 may be approximately equal to the total number of subcarriers included in the SRC signal 202 and/or the adjacent SRC signal 208. However, due to the greater channel bandwidth associated with the second SRC channel 218, the wireless signal 216 may be associated with greater and/or larger subcarrier spacing than the SRC signal 202 and/or the adjacent SRC signal 208. Furthermore, the wireless signal 216 may be capable of multi-input multi-output (MIMO) orthogonal frequency-division multiplexing (OFDM), whereas the SRC signal 202 and the adjacent SRC signal 208 may lack this capability. Further still, in certain implementations, the SRC signal and the adjacent SRC signal 208 may conform to the IEEE 802.11p wireless standard. In addition, the wireless signal 216 may conform to the subcarrier allocation criteria (e.g., the number of allowed subcarriers) set forth by the IEEE 802.11a wireless standard. However, the wireless signal 216 may otherwise conform to and/or otherwise include the features set forth in the IEEE 802.11n standard, such as MIMO OFDM capability.

Furthermore, the second SRC channel 218 may include a wireless signal buffer zone 222 comprised of one or more wireless signal guard subcarriers 224A-N. The wireless signal buffer zone 222 may be a portion of the second SRC channel 218, directly bordering the first SRC channel 204, in which no data can be transmitted. As a result of the greater subcarrier spacing associated with the wireless signal 216 compared to the SRC signal 202 and the adjacent SRC signal 208, and the approximately equal number of subcarriers included in the wireless signal 216 compared to the number of subcarriers included in the SRC signal 202 and the adjacent SRC signal 208, the size of the wireless signal buffer zone 222 may be greater than the size of the adjacent SRC signal buffer zone 214. The larger size of the wireless signal buffer zone 222 may result in less interference by the wireless signal 216 on the SRC signal 202 compared to the interference by the adjacent SRC signal 208 on the SRC signal 202. In other words, the second SRC channel 208 may include a larger frequency range, adjacent to the first SRC channel 204, in which the wireless signal 216 does not transmit data, thereby reducing interference on the SRC signal 202 in the first SRC channel 204.

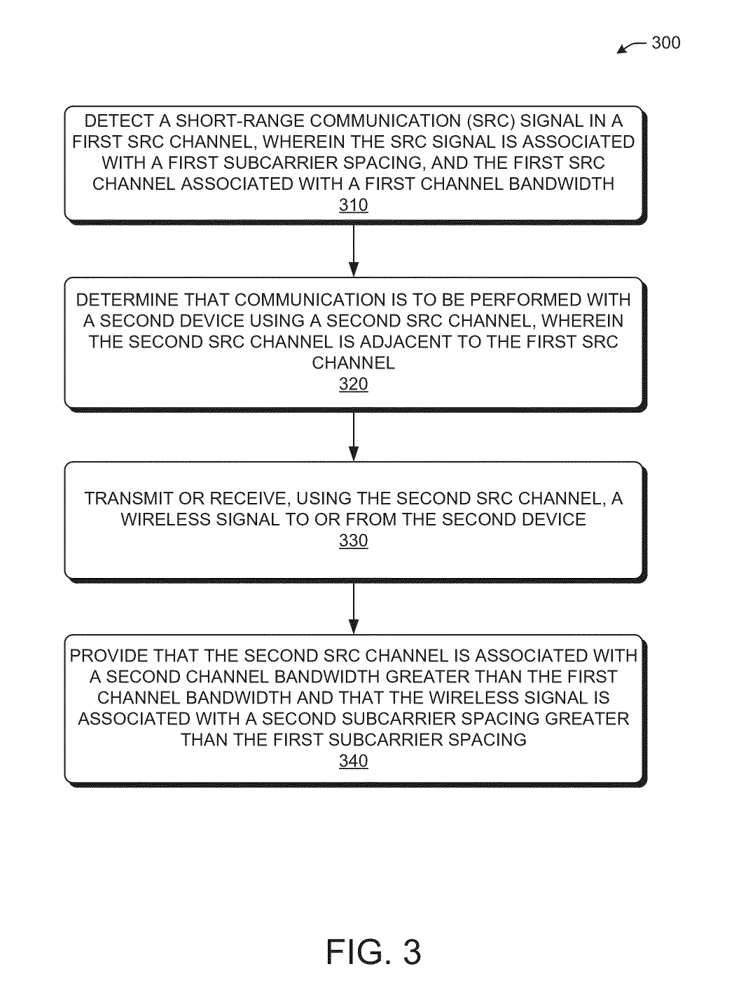

Referring now to FIG. 3, a flow diagram of a method 300 is illustrated for reducing interference in short-range communication channels in accordance with one or more example embodiments. The method 300 may begin in block 310, where a computer, such as a first device 102, may detect communication of a SRC signal in a first SRC channel. As previously discussed, the SRC signal may be transmitted, received, and/or otherwise communicated by a vehicle communication system (e.g., vehicle communication system 136). In block 320, the first device 102 may also determine that communication is to be performed with another device, such as the second device 120. In block 330, the first device 102 may identify a second a second SRC channel, adjacent to the first SRC channel, in which to communicate with the second device 120.

In block 340, the first device 102 may transmit, to the second device 120 using the second SRC channel, a wireless signal with different signal characteristics than the SRC signal. For example wireless signal may be associated with a greater subcarrier spacing than that of the SRC signal. Furthermore, the second SRC channel may be associated with a greater channel bandwidth than that of the first SRC channel. The second SRC channel may also include a buffer zone comprised of one or more guard subcarriers in the wireless signal. The buffer zone may be a portion of the second SRC channel in which data is prevented from being transmitted.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Examples

Example 1 is a device for wireless communication, comprising: at least one antenna; a radio transceiver; at least one processor; and at least one memory storing computer-executable instructions, that when executed by the at least one processor, causes that at least one processor to: detect a short-range communication (SRC) signal in a first SRC channel, wherein the SRC signal is associated with a first subcarrier spacing, and the first SRC channel associated with a first channel bandwidth; determine that communication is to be performed with a second device using a second SRC channel, wherein the second SRC channel is adjacent to the first SRC channel; and transmit, using the second SRC channel, a wireless signal to the second device, wherein: the second SRC channel is associated with a second channel bandwidth greater than the first channel bandwidth, and the wireless signal is associated with a second subcarrier spacing greater than the first subcarrier spacing.

In Example 2, the subject matter of Example 1 can optionally include that the short-range communication signal is associated with a vehicle communication system associated with a vehicle.

In Example 3, the subject matter of Example 1 can optionally include that the first SRC channel is a dedicated short-range communication (DSRC) channel.

In Example 4, the subject matter of Example 1 can optionally include that the second SRC channel is a dedicated short-range communication (DSRC) channel.

In Example 5, the subject matter of Example 1 can optionally include that wherein the first channel bandwidth is approximately 10 Megahertz (MHz), and the second channel bandwidth is approximately 20 MHz.

In Example 6, the subject matter of Example 1 can optionally include that a first number of subcarriers associated with the SRC signal is equal to a second number of subcarriers associated with the wireless signal.

In Example 7, the subject matter of Example 1 can optionally include that the second SRC channel comprises a buffer zone in which data is prevented from being transmitted, wherein the buffer zone is directly adjacent to the first SRC channel.

In Example 8, the subject matter of Example 1 can optionally include that the wireless signal comprises a multi-input multi-output (MIMO) orthogonal frequency-division multiplexing (OFDM) signal

Example 9 is a method for wireless communication, comprising: identifying, by a device comprising one or more processors, a short-range communication (SRC) signal in a first SRC channel, wherein the SRC signal is associated with a first subcarrier spacing, and the first SRC channel associated with a first channel bandwidth; determining that the device is to communicate with a second device using a second SRC channel adjacent to the first SRC channel; and transmitting or receiving using the second SRC channel, a wireless signal to or from the second device, wherein: the second SRC channel is associated with a second channel bandwidth greater than the first channel bandwidth, and the wireless signal is associated with a second subcarrier spacing greater than the first subcarrier spacing.

In Example 10, the subject matter of Example 9 can optionally include that the short-range communication signal is transmitted or received by a vehicle communication system associated with a vehicle.

In Example 11, the subject matter of Example 9 can optionally include that the first SRC channel is a dedicated short-range communication (DSRC) channel.

In Example 12, the subject matter of Example 9 can optionally include that the second SRC channel is a dedicated short-range communication (DSRC) channel.

In Example 13, the subject matter of Example 9 can optionally include that the first channel bandwidth is approximately 10 Megahertz (MHz), and the second channel bandwidth is approximately 20 MHz.

In Example 14, the subject matter of Example 9 can optionally include that a first number of subcarriers associated with the SRC signal is equal to a second number of subcarriers associated with the wireless signal.

In Example 15, the subject matter of Example 9 can optionally include that the second SRC channel comprises a buffer zone in which data is prevented from being transmitted, wherein the buffer zone is directly adjacent to the first SRC channel.

In Example 16, the subject matter of Example 9 can optionally include that the wireless signal comprises a multi-input multi-output (MIMO) orthogonal frequency-division multiplexing (OFDM) signal

Example 17 is a non-transitory computer-readable medium comprising instructions, that when executed by at least one processor, cause the at least one processor to: identify a short-range communication (SRC) signal in a first SRC channel, wherein the SRC signal is associated with a first subcarrier spacing, and the first SRC channel associated with a first channel bandwidth; determine that communication is to be performed with a second device using a second SRC channel adjacent to the first SRC channel; and transmit or receive, using the second SRC channel, a wireless signal to or from the second device, wherein: the second SRC channel is associated with a second channel bandwidth greater than the first channel bandwidth, and the wireless signal is associated with a second subcarrier spacing greater than the first subcarrier spacing.

In Example 18, the subject matter of Example 17 can optionally include that the short-range communication signal is transmitted or received by a vehicle communication system associated with a vehicle.

In Example 19, the subject matter of Example 17 can optionally include that the first SRC channel is a dedicated short-range communication (DSRC) channel.

In Example 20, the subject matter of Example 17 can optionally include that the second SRC channel is a dedicated short-range communication (DSRC) channel.

In Example 21, the subject matter of Example 7 can optionally include that the first channel bandwidth is approximately 10 Megahertz (MHz), and the second channel bandwidth is approximately 20 MHz.

In Example 22, the subject matter of Example 7 can optionally include that a first number of subcarriers associated with the SRC signal is equal to a second number of subcarriers associated with the wireless signal

In Example 23, the subject matter of Example 7 can optionally include that the second SRC channel comprises a buffer zone in which data is prevented from being transmitted, wherein the buffer zone is directly adjacent to the first SRC channel.

In Example 24, the subject matter of Example 7 can optionally include that the wireless signal comprises a multi-input multi-output (MIMO) orthogonal frequency-division multiplexing (OFDM) signal.

Example 25 is an apparatus for wireless communication, comprising: means for identifying, by a device comprising one or more processors, a short-range communication (SRC) signal in a first SRC channel, wherein the SRC signal is associated with a first subcarrier spacing, and the first SRC channel associated with a first channel bandwidth; means for determining that the device is to communicate with a second device using a second SRC channel adjacent to the first SRC channel; and means for transmitting or receiving using the second SRC channel, a wireless signal to or from the second device, wherein: the second SRC channel is associated with a second channel bandwidth greater than the first channel bandwidth, and the wireless signal is associated with a second subcarrier spacing greater than the first subcarrier spacing.

In Example 26, the subject matter of Example 25 can optionally include that the short-range communication signal is transmitted or received by a vehicle communication system associated with a vehicle.

In Example 27, the subject matter of Example 25 can optionally include that the first SRC channel is a dedicated short-range communication (DSRC) channel.

In Example 28, the subject matter of Example 25 can optionally include that the second SRC channel is a dedicated short-range communication (DSRC) channel.

In Example 29, the subject matter of Example 25 can optionally include that the first channel bandwidth is approximately 10 Megahertz (MHz), and the second channel bandwidth is approximately 20 MHz.

In Example 30, the subject matter of Example 25 can optionally include that a first number of subcarriers associated with the SRC signal is equal to a second number of subcarriers associated with the wireless signal.

In Example 31, the subject matter of Example 25 can optionally include that the second SRC channel comprises a buffer zone in which data is prevented from being transmitted, wherein the buffer zone is directly adjacent to the first SRC channel.

In Example 32, the subject matter of Example 25 can optionally include that wireless signal comprises a multi-input multi-output (MIMO) orthogonal frequency-division multiplexing (OFDM) signal.

What is claimed is:

1. A device for wireless communication, comprising:
at least one antenna;
a radio transceiver;
at least one processor; and
at least one memory storing computer-executable instructions, that when executed by the at least one processor, causes that at least one processor to:
detect a short-range communication (SRC) signal in a first SRC channel, wherein the SRC signal is associated with a first subcarrier spacing, and the first SRC channel associated with a first channel bandwidth;
determine that communication is to be performed with a second device using a second SRC channel, wherein the second SRC channel is adjacent to the first SRC channel; and
transmit, using the second SRC channel, a wireless signal to the second device, wherein:
the second SRC channel is associated with a second channel bandwidth greater than the first channel bandwidth, and
the wireless signal is associated with a second subcarrier spacing greater than the first subcarrier spacing.

2. The device of claim 1, wherein the short-range communication signal is associated with a vehicle communication system associated with a vehicle.

3. The device of claim 1, wherein the first SRC channel is a dedicated short-range communication (DSRC) channel.

4. The device of claim 1, wherein the second SRC channel is a dedicated short-range communication (DSRC) channel.

5. The device of claim 1, wherein the first channel bandwidth is approximately 10 Megahertz (MHz), and the second channel bandwidth is approximately 20 MHz.

6. The device of claim 1, wherein a first number of subcarriers associated with the SRC signal is equal to a second number of subcarriers associated with the wireless signal.

7. The device of claim 1, wherein the second SRC channel comprises a buffer zone in which data is prevented from being transmitted.

8. The device of claim 1, wherein the wireless signal comprises a multi-input multi-output (MIMO) orthogonal frequency-division multiplexing (OFDM) signal.

9. A method for wireless communication, comprising:
identifying, by a device comprising one or more processors, a short-range communication (SRC) signal in a first SRC channel, wherein the SRC signal is associated with a first subcarrier spacing, and the first SRC channel associated with a first channel bandwidth;
determining that the device is to communicate with a second device using a second SRC channel adjacent to the first SRC channel; and
transmitting or receiving using the second SRC channel, a wireless signal to or from the second device, wherein:
the second SRC channel is associated with a second channel bandwidth greater than the first channel bandwidth, and
the wireless signal is associated with a second subcarrier spacing greater than the first subcarrier spacing.

10. The method of claim 9, wherein the short-range communication signal is transmitted or received by a vehicle communication system associated with a vehicle.

11. The method of claim 9, wherein the first SRC channel is a dedicated short-range communication (DSRC) channel.

12. The method of claim 9, wherein the second SRC channel is a dedicated short-range communication (DSRC) channel.

13. The method of claim 9, wherein the first channel bandwidth is approximately 10 Megahertz (MHz), and the second channel bandwidth is approximately 20 MHz.

14. The method of claim 9, wherein a first number of subcarriers associated with the SRC signal is equal to a second number of subcarriers associated with the wireless signal.

15. The method of claim 9, wherein the second SRC channel comprises a buffer zone in which data is prevented from being transmitted

16. The method of claim 9, wherein the wireless signal comprises a multi-input multi-output (MIMO) orthogonal frequency-division multiplexing (OFDM) signal.

17. A non-transitory computer-readable medium comprising instructions, that when executed by at least one processor, cause the at least one processor to:
identify a short-range communication (SRC) signal in a first SRC channel, wherein the SRC signal is associated with a first subcarrier spacing, and the first SRC channel associated with a first channel bandwidth;
determine that communication is to be performed with a second device using a second SRC channel adjacent to the first SRC channel; and
transmit or receive, using the second SRC channel, a wireless signal to or from the second device, wherein:
the second SRC channel is associated with a second channel bandwidth greater than the first channel bandwidth, and
the wireless signal is associated with a second subcarrier spacing greater than the first subcarrier spacing.

18. The computer-readable medium of claim 17, wherein the short-range communication signal is transmitted or received by a vehicle communication system associated with a vehicle.

19. The computer-readable medium of claim 17, wherein the first SRC channel is a dedicated short-range communication (DSRC) channel.

20. The computer-readable medium of claim 17, wherein the second SRC channel is a dedicated short-range communication (DSRC) channel.

21. The computer-readable medium of claim 17, wherein the first channel bandwidth is approximately 10 Megahertz (MHz), and the second channel bandwidth is approximately 20 MHz.

22. The computer-readable medium of claim 17, wherein a first number of subcarriers associated with the SRC signal is equal to a second number of subcarriers associated with the wireless signal.

23. The computer-readable medium of claim 17, wherein the second SRC channel comprises a buffer zone in which data is prevented from being transmitted

24. The computer-readable medium of claim 17, wherein the wireless signal comprises a multi-input multi-output (MIMO) orthogonal frequency-division multiplexing (OFDM) signal.
